(19) United States
(12) Patent Application Publication
(10) Pub. No.: US 2023/0031976 A1
(43) Pub. Date: Feb. 2, 2023

(54) ANTIBACTERIAL GLASS COMPOSITION AND METHOD FOR PREPARING SAME

(71) Applicant: LG ELECTRONICS INC., Seoul (KR)

(72) Inventors: Daesung KIM, Seoul (KR); Namjin KIM, Seoul (KR); Young Seok KIM, Seoul (KR)

(21) Appl. No.: 17/786,228

(22) PCT Filed: Dec. 16, 2020
(86) PCT No.: PCT/KR2020/018479

§ 371 Date: Jun. 16, 2022

(30) Foreign Application Priority Data
Dec. 17, 2019 (KR) 10-2019-0168500
Jan. 17, 2020 (KR) 10-2020-0006891

(51) Int. Cl. C03C 3/064; C03C 12/00; A01N 59/16; A01N 25/12; A01P 1/00

(52) U.S. Cl. CPC C03C 3/064; C03C 12/00; A01N 59/16; A01N 25/12; A01P 1/00

(57) ABSTRACT

The present disclosure relates to an antibacterial glass composition and a manufacturing method thereof. The antibacterial glass composition according to the present disclosure comprises 20 to 40 wt % of SiO₂; 5 to 25 wt % of B₂O₃; 15 to 25 wt % of one or more of Na₂O, K₂O and Li₂O; and 25 to 45 wt % of CaO, preventing a deterioration in durability and having an excellent antibacterial property. Additionally, the present disclosure relates to an antibacterial glass composition and a manufacturing method of antibacterial glass powder using the same that is a novel silicate glass composition, is transparent and colorless and has an excellent antibacterial property and a high antifungal activation level, such that when the antibacterial glass composition is used as a coating agent of a glass shelf, an additive of a plastic injection molded product and the like, the antibacterial glass composition prevents the deformation of the exteriors of the glass shelf, the plastic injection molded product and the like.

### TECHNICAL FIELD

Disclosed herein are an antibacterial glass composition having an antibacterial property, and a manufacturing method thereof.

### BACKGROUND ART

Microorganisms such as germs, viruses and bacteria are found in all places, in particular, a washbasin, shelves in a fridge or a washing machine that are used in our daily lives. When such microorganisms invade the human body, they can infect the human body and become a serious threat to human health. Under the circumstances, there is a growing need for an antibacterial glass composition capable of controlling the spread of microorganisms to household goods such as a washbasin, shelves in a fridge, an oven, or a washing machine and the like.

In the related art, an antibacterial glass composition includes various sorts of metal oxides, to increase the number of positive hydrogen ions that are generated from moisture and the metal oxides. Accordingly, an acid environment is created in a water-soluble medium, and microorganisms are killed in the acid environment. However, the above-described antibacterial glass composition cannot ensure water resistance, and the acid environment needs to be created.

In addition, an antibacterial glass composition that performs antibacterial activity thanks to the elution of ions such as Ag, Zn, and Au is well-known. However, the elements are harmful to the human body, and expensive. Costs of manufacturing an antibacterial glass composition increases when the antibacterial glass composition contains the above elements, and the above elements can cause a toxic effect on the human body.

Further, there is a growing demand for an antibacterial glass composition capable of preventing the spread of microorganisms to the furniture, medical tools, a container for disinfectant liquids and the like in a hospital as well as a household product such as a washbasin, a shelf in a refrigerator, an oven, a washing machine and the like.

In the related art, an antibacterial glass composition includes molybdenum oxides, to increase the number of positive hydrogen ions that are generated from moisture and the molybdenum oxides. Accordingly, an acid environment is created in a water-soluble medium, and microorganisms are killed in the acid environment.

However, the antibacterial glass composition including mono molybdenum oxides cannot ensure water resistance properly, and the acid environment needs to be created.

To ensure sufficient water resistance, an antibacterial glass composition includes compound oxides in which molybdenum and silver or molybdenum and copper are combined. However, in the antibacterial glass composition including the compound oxides, a ratio of molybdenum decreases. Accordingly, an acid environment of a water-soluble medium can hardly be created, causing a deterioration of an antibacterial property.

### Patent Document

(Document 1)
JP Patent No. 3845975
(Document 2)
KR Patent Publication No. 10-2016-0124193

[symbol]

### DESCRIPTION OF INVENTION

### Technical Problems

The objective of the present disclosure is to provide a novel composition of antibacterial glass that is based on the elution of components harmless to the human body.

The objective of the present disclosure is to provide a novel and economical antibacterial glass composition that excludes costly components.

The objective of another embodiment in the present disclosure is to provide an antibacterial glass composition and a manufacturing method of antibacterial glass powder using the same that is a novel silicate glass composition, is transparent and colorless and has an excellent antibacterial property and a high antifungal activation level, such that when the antibacterial glass composition is used as a coating agent of a glass shelf, an additive for a plastic injection molded product and the like, the antibacterial glass composition prevents the deformation of the exteriors of the glass shelf, the plastic injection molded product and the like.

The objective of another embodiment in the present disclosure is to provide an antibacterial glass composition and a manufacturing method of antibacterial glass powder using the same in which Ag oxides are slightly added rather than Cu oxides, Fe oxides and the like and which has an excellent antibacterial effect and keeps glass transparent.

### Technical Solutions

According to the present disclosure, an antibacterial glass composition includes 25 to 45 wt % of CaO harmless to the human body, and the composition ratios of the other components are controlled properly.

Specifically, the antibacterial glass composition according to the present disclosure includes 20 to 40 wt % of SiO₂; 5 to 25 wt % of B₂O₃; 15 to 25 wt % of one or more of Na₂O, K₂O and Li₂O; and 25 to 45 wt % of CaO, preventing a deterioration in durability and exhibiting an excellent antibacterial property.

In the antibacterial glass composition, SiO₂ content may be greater than B₂O₃ content, and 30 wt % or greater of CaO may be included.

In an antibacterial glass composition and a manufacturing method of antibacterial glass powder using the same of another embodiment in the preset disclosure, the antibacterial glass composition is a novel silicate glass composition, is transparent and colorless, and has an excellent antibacterial property and a high antifungal activation level.

Thus, in the antibacterial glass composition and the manufacturing method of antibacterial glass powder using the same according to the preset disclosure, when being used as a coating agent for a glass shelf, an additive for a plastic injection molded product and the like, the antibacterial glass composition prevents the deformation of the exteriors of the glass shelf, the plastic injection molded product and the like.

Additionally, in the antibacterial glass composition of another embodiment in the preset disclosure, Ag oxides are slightly added rather than Cu oxides, Fe oxides and the like, producing an excellent antibacterial effect and keeping glass transparent.

To this end, the antibacterial glass composition of another embodiment includes 20 to 45 wt % of SiO₂; 5 to 40 wt % of B₂O₃; 5 to 30 wt % of one or more of Na₂O, K₂O and Li₂O; 5 to 20 wt % of CaO; and 0.01 to 2 wt % of one or more of Ag₂O, Ag₃PO₄ and AgNO₃.

The antibacterial glass composition according to the present disclosure may further include 15 wt % or less of TiO2.

### Advantageous Effects

In an antibacterial glass composition according to the present disclosure, a composition ratio is adjusted, preventing a deterioration water resistance and durability, despite the elution of Ca ions.

Additionally, the antibacterial glass composition can be applied to various types of products as a multipurpose antibacterial agent.

Further, the antibacterial glass composition includes no expensive component, ensuring cost efficiency.

An antibacterial glass composition and a manufacturing method of antibacterial glass powder using the same in another embodiment involves a novel silicate glass composition that is transparent and colorless, and has an excellent antibacterial property and a high antifungal activation level, such that when being used as a coating agent for a glass shelf, an additive for a plastic injection molded product and the like, the antibacterial glass composition prevents the deformation of the exteriors of the glass shelf, the plastic injection molded product and the like.

Furthermore, in the antibacterial glass composition and the manufacturing method of antibacterial glass powder using the same, Ag oxides are slightly added rather than Cu oxides, Fe oxides and the like, producing an excellent antibacterial effect and keeping glass transparent.

Thus, in the antibacterial glass composition and the manufacturing method of antibacterial glass powder using the same, each component and a composition ratio of each component are controlled, ensuring an excellent antibacterial property and a high antifungal activation level as well as excellent durability. Accordingly, the antibacterial glass composition can be used as a coating agent for a glass shelf, and an additive for a plastic injection molded product.

Specific effects are described along with the above-described effects in the section of detailed description.

### BRIEF DESCRIPTION OF DRAWINGS

FIG. 1 is a processing flow chart showing a manufacturing method of antibacterial glass powder in another embodiment.

### DETAILED DESCRIPTION OF EXEMPLARY EMBODIMENTS

The above-described aspects, features and advantages are specifically described hereafter with reference to the accompanying drawings such that one having ordinary skill in the art to which the present disclosure pertains can embody the technical spirit of the disclosure easily. In the disclosure, detailed description of known technologies in relation to the disclosure is omitted if it is deemed to make the gist of the disclosure unnecessarily vague. Below, preferred embodiments according to the disclosure are specifically described with reference to the accompanying drawings. In the drawings, identical reference numerals can denote identical or similar components.

When one component is described as being “in the upper portion (or the lower portion)” or “on (or under)” another component, one component can be directly on (or under) another component, and an additional component can be interposed between the two components.

When any one component is described as being “connected”, “coupled”, or “connected” to another component, any one component can be directly connected or coupled to another component, but an additional component can be “interposed” between the two components or the two components can be “connected”, “coupled”, or “connected” by an additional component.

Throughout the disclosure, each component can be provided as a single one or a plurality of ones, unless stated to the contrary.

In the disclosure, singular forms include plural forms as well, unless explicitly indicated otherwise. It is to be understood that the terms such as “comprise” or “include” and the like, when used in this disclosure, are not interpreted as necessarily including stated components or steps, but can be interpreted as excluding some of the stated components or steps or as further including additional components or steps.

Throughout the disclosure, the terms “A and/or B” as used herein can denote A, B or A and B, and the terms “C to D” can denote C or greater and D or less, unless stated to the contrary.

Hereafter, an antibacterial glass composition, and a manufacturing method thereof according to the present disclosure are described specifically.

<Antibacterial Glass Composition 1>

An antibacterial glass composition according to the present disclosure is comprised of 20 to 40 wt % of SiO₂; 5 to 25 wt % of B₂O₃; 15 to 25 wt % of one or more of Na₂O, K₂O and Li₂O; and 25 to 45 wt % of CaO.

The antibacterial glass composition according to the present disclosure exhibits an excellent antibacterial property and durability thanks to the elution of Ca ions. Hereafter, components of the antibacterial glass composition according to the present disclosure are described specifically.

SiO₂ is an essential component that forms a glass structure and serves as a skeleton of the glass structure. The antibacterial glass composition according to the present disclosure includes 20 to 40 wt % of SiO₂. When greater than 40 wt % of SiO₂ is included, viscosity increases when glass melts. Accordingly, workability may deteriorate during quenching. When less than 20 wt % of SiO₂ is included, the glass structure may be weaken, causing a deterioration in water resistance.

The antibacterial glass composition according to the present disclosure includes 5 to 25 wt % of B₂O₃. When greater than 25 wt % of B₂O₃ is included, B₂O₃ interferes with the content of the other components, resulting in a deterioration in the antibacterial property. When less than 5 wt % of B₂O₃ is included, the glass structure may be weaken, causing a deterioration in water resistance.

In the antibacterial glass composition of the present disclosure, it would be preferable to include SiO₂ more than B₂O₃. When the antibacterial glass composition of the present disclosure has a composition ratio at which the content of SiO₂ is greater than the content of B₂O₃, proper water resistance may be ensured despite the elution of Ca ions.

Alkali oxides such as Na₂O, K₂O and Li₂O perform cross-linking in the composition of glass and serve as a mesh modifier. Some of the above-described components cannot be vitrified solely, but can be vitrified when being mixed with the mesh former such as SiO₂, B₂O₃ and the like at a predetermined ratio. When only one of the above-described components is included in the glass composition, the durability of glass may deteriorate in a zone where vitrification is possible. When two or more of the above-described components are included in the glass composition, the durability of glass may improve depending on a ratio. The antibacterial glass composition according to the present disclosure includes 15 to 25 wt % of one or more of Na₂O, K₂O and Li₂O. When greater than 25 wt % of one or more of Na₂O, K₂O and Li₂O is included in the glass composition, the durability of the composition may deteriorate significantly. When less than 15 wt % of one or more of Na₂O, K₂O and Li₂O is included, the hydrolysis of a component such as CaO is hardly controlled, causing a deterioration in an antibacterial property.

In the present disclosure, CaO is a critical component that exhibits an antibacterial property in the composition of glass. CaO is a component that forms Ca ions by reacting with surrounding water. The antibacterial glass composition according to the present disclosure includes 25 to 45 wt % of CaO. In the antibacterial glass composition according to the present disclosure, pH of surrounding water increases to 10 or greater because of the elution if Ca ions, and an environment where strains cannot live is created around areas to which the antibacterial glass composition according to the present disclosure is applied. Additionally, an increase in the content of CaO in the antibacterial glass composition causes a deterioration in the durability of the composition of glass. However, in the present disclosure, the content of the other components is controlled to prevent a deterioration in durability. When less than 25 wt % of CaO is included, the antibacterial property in the composition of glass is hardly exhibited, since the amount of Ca ions, eluted as a result of a reaction with surrounding water, is short. When greater than 45 wt % of CaO is included, the vitrification in the composition of glass is hardly ensured, causing a deterioration in durability and thermal properties. The antibacterial glass composition according to the present disclosure may include 30 wt % or greater of CaO, for example.

<Manufacturing Method of Antibacterial Glass Composition>

Hereafter, a manufacturing method of an antibacterial glass composition according to the present disclosure is described specifically.

The manufacturing method of an antibacterial glass composition according to the present disclosure includes providing above-described antibacterial glass composition materials; melting the antibacterial glass composition materials; and cooling the melted antibacterial glass composition materials in a quenching roller and forming an antibacterial glass composition.

The antibacterial glass composition materials sufficiently mix, and then melt. For example, the antibacterial glass composition materials may melt in a range of 1200 to 1300° C. in an electric furnace. Additionally, the antibacterial glass composition materials may melt for 10-60 minutes.

Then the melted antibacterial glass composition materials may cool rapidly using a chiller and the like in the quenching roller. As a result, an antibacterial glass composition can be formed.

<Application Method of Antibacterial Glass Composition>

Then the antibacterial glass composition according to the disclosure can be coated on one surface of an object to be coated. The object to be coated may be part or all of a metallic plate, a tempered glass plate, and a cooking appliance. As a way of coating the object to be coated, a coating liquid is applied to the surface of the object to be coated and burned. A spray method can also be used to coat the object to be coated. However, the coating method is not limited. The antibacterial glass composition can be burned in a range of 700 to 750° C. for 300 to 450 seconds.

Additionally, antibacterial glass according to the present disclosure can be applied to a plastic resin injection molded object, as an additive. A proper amount of the antibacterial glass powder according to the present disclosure can be included in a plastic resin injection molded product, to apply antibacterial activity to the surface of the injection molded object.

Hereafter, take a look at detailed aspects according to the preset disclosure with reference to embodiments.

<Antibacterial Glass Composition 2>

An antibacterial glass composition in another embodiment is a novel silicate glass composition that is transparent and colorless, and has an excellent antibacterial property and a high antifungal activation level. When being used as a coating agent for a glass shelf, an additive for a plastic injected product, and the like, the antibacterial glass composition can prevent the deformation of the exteriors of the glass shelf, the plastic injection molded product and the like.

The antibacterial glass composition is comprised of two elements including a glass matrix that forms a glass structure and adjusts durability, and a metal ion that is included in glass exhibiting antibacterial activity.

The antibacterial glass composition in another embodiment includes Ag oxides, and to manufacture a glass matrix that can be used practically and exhibits water resistance, the content of B₂O₃ is strictly controlled and added at 5 to 40 wt %. B₂O₃ helps with the vitrification of Ag ions producing an antibacterial effect. However, when a predetermined amount or greater of B₂O₃ is included, water resistance can deteriorate. Further, to ensure water resistance of glass containing large amounts of B₂O₃, a composition ratio of the content of a component such as TiO₂ and CaO that serves as a mesh modifier as well as a mesh former to the content of alkali components is strictly controlled.

Thus, in the antibacterial glass composition of another embodiment, Ag oxides are slightly added rather than Cu oxides, Fe oxides and the like, to have an excellent antibacterial effect and keep glass transparent.

To this end, the antibacterial glass composition of another embodiment is comprised of 20 to 45 wt % of SiO₂; 5 to 40 wt % of B₂O₃; 5 to 30 wt % of one or more of Na₂O, K₂O and Li₂O; 5 to 20 wt % of CaO; and 0.01 to 2 wt % of one or more of Ag₂O, Ag₃PO₄ and AgNO₃.

The antibacterial glass composition of another embodiment may further include 15 wt % or less of TiO₂.

Additionally, in the antibacterial glass composition of another embodiment, each component and its composition ratio are controlled, to have an excellent antibacterial property and a high antifungal activation level as well as durability.

Thus, the antibacterial glass composition of another embodiment can be used as a coating agent for a glass shelf, and an additive for a plastic injected product.

Hereafter, the role and content of each component of the antibacterial glass composition of another embodiment are described specifically.

SiO₂ is a glass former that enables vitrification, and an essential component that serves as a structural skeleton of glass. Additionally, SiO₂ does not act as a direct component that exhibit antibacterial activity, but is useful to form less OH groups on the surface of glass compared to P₂O₅ that is a representative glass former and to allow the surface of glass to be positively charged because of metal ions in the glass.

For example, SiO₂ is included at the content ratio of 20 to 46 wt % of the total weight of the antibacterial glass composition of another embodiment. Preferably, 30 to 40 wt % of SiO₂ is included. When greater than 45 wt % of SiO₂ is included, viscosity increases when glass melts. Accordingly, workability and yield may deteriorate during cooling. When less than 20 wt % of SiO₂ is included, the glass structure may be weaken, causing a deterioration in water resistance.

B₂O₃ serves as a glass former together with SiO₂ such that a glass composition is vitrified. Since B₂O₃ has a low melting point, B₂O₃ helps to lower a eutectic point of a molten material. Additionally, B₂O₃ helps to improve the solubility of one or more of Ag₂O, AgNO₃ and Ag₃PO₄ that are hardly vitrified due to their lower coupling strength than glass with high silicate content during the glass melting process, ensuring the homogeneity of glass.

B₂O₃ is included at the content ratio of 5 to 40 wt % of the total weight of the antibacterial glass composition of another embodiment, for example. Preferably, B₂O₃ can be included at 30 to 38 wt %. When greater than 40 wt % of B₂O₃ is included, B₂O₃ interferes with the content of the other components, resulting in a deterioration in an antibacterial property. When less than 5 wt % of B₂O₃ is included, the coupling structure of glass may be weaken, causing a deterioration in water resistance.

In another embodiment, SiO₂ is added more than B₂O₃, for example, to ensure water resistance.

Alkali oxides such as Na₂O, K₂O and Li₂O serve as a mesh modifier that performs cross-linking in the composition of glass. The components cannot be vitrified solely, but can be vitrified when being mixed with the mesh former such as SiO₂, B₂O₃ and the like at a predetermined ratio. When only one of the components is included in the glass composition, the durability of glass may deteriorate in a zone where vitrification is possible. When two or more of the components are included in the glass composition, the durability of glass may improve depending on a ratio. This phenomenon is referred to as a mixed alkali effect.

For example, one or more of Na₂O, K₂O and Li₂O is included at the content ratio of 5 to 30 wt % of the total weight of the antibacterial glass composition according to the present disclosure. When greater than 30 wt % of one or more of Na₂O, K₂O and Li₂O is included in the glass composition, the thermal property of the composition may deteriorate. When less than 5 wt % of one or more of Na₂O, K₂O and Li₂O is included, the hydrolysis of a component such as ZnO is hardly controlled, causing a deterioration in an antibacterial property.

CaO is a component that serves as a mesh modifier as well as a mesh former from a structural aspect of glass. Additionally, CaO is one of the essential components that exhibits an antibacterial property in the composition of glass.

For example, CaO is included at the content ratio of 5 to 20 wt % of the total weight of the antibacterial glass composition of another embodiment. When less than 5 wt % of CaO is included, the antibacterial property in the composition of glass is hardly displayed. When greater than 20 wt % of CaO is included, the durability or thermal property in the composition of glass may deteriorate.

Aluminum oxides such as Ag₂O, Ag₃PO₄ and AgNO₃ are essential components that enables glass to produce an antibacterial effect in itself. Since Ag₂O, Ag₃PO₄ and AgNO₃ show a low tendency of ionization, Ag₂O, Ag₃PO₄ and AgNO₃ are easily precipitated as Ag metal when being contained in silicate glass, ensuring no homogeneity of glass. In the present disclosure, when 5 to 40 wt %, preferably, 30 to 38 wt %, of B₂O₃ is included, B₂O₃ weakens a coupling strength, ensuring homogeneity of glass where Ag is present reliably in an ionized form, in glass.

When less than 0.01 wt % of one or more of Ag₂O, Ag₃PO₄ and AgNO₃ s included, improvement in the antibacterial property of glass may not be ensured. When greater than 2 w % of one or more of Ag₂O, Ag₃PO₄ and AgNO₃ is included, Ag metal is precipitated, causing the instability in vitrification.

In the present disclosure, it is preferable that B₂O₃ and one or more of Ag₂O, Ag₃PO₄ and AgNO₃ satisfy formula 1 described hereafter.

[B₂O₃]/[one or more of Ag₂O,Ag₃PO₄ and AgNO₃]≤50 Formula 1:

(In formula 1, [ ] denotes wt % of each component.)

Ag shows a low tendency of ionization and is easily reduced. Glass containing large amounts of B₂O₃ has a lower coupling strength than glass with high SiO₂ content, ensuring ease of ionization of Ag.

However, when a ratio of [B₂O₃]/[one or more of Ag₂O, Ag₃PO₄ and AgNO₃] is less than 50 in formula 1 described above, Ag metal is precipitated, causing the instability in vitrification. When the ratio of [B₂O₃]/[one or more of Ag₂O, Ag₃PO₄ and AgNO₃] is 50 or greater as shown in formula 1, Ag metal is not precipitated, and vitrification is reliably performed.

TiO₂ is a component that improves the chemical durability and heat resistance and the like of glass. When greater than 15 wt % of TiO₂ is included, devitrification or unmixing may occur during cooling, out of a vitrification zone. For example, TiO₂ is included at the content ratio of 15 wt % or less of the total weight of the antibacterial glass composition of another embodiment.

In another embodiment, a total content of 5 wt % or greater of CaO and TiO₂ needs to added. Then water resistance weakened because of a relatively large amount of added B₂O₃ may improve. However, when the total content of CaO and TiO₂ is greater than 30 wt %, devitrification or unmixing may occur, causing a deterioration in water resistance.

To prevent this from happening, the total content of CaO and TiO₂ is limited to 5 to 30 wt % of the total weight of the antibacterial glass composition of another embodiment, for example.

Hereafter, a manufacturing method of antibacterial glass powder in another embodiment is described with reference to the accompanying drawings.

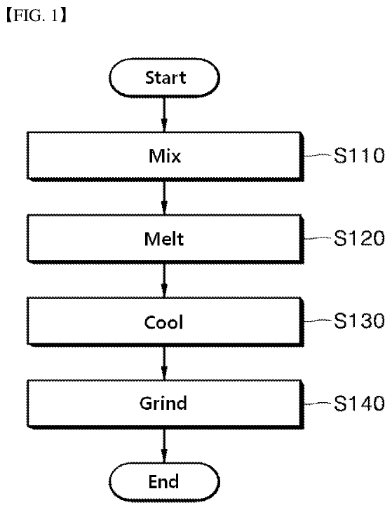

FIG. 1 is a processing flow chart showing a manufacturing method of antibacterial glass powder in another embodiment.

As illustrated in FIG. 1, the manufacturing method of antibacterial glass powder in another embodiment includes a mixing step (S110), a melting step (S120), a cooling step (S130) and a grinding step (S140).

Mixing Step

In the mixing step (S110), 20 to 45 wt % of SiO₂; 5 to 40 wt % of B₂O₃; 5 to 30 wt % of one or more of Na₂O, K₂O and Li₂O; 5 to 20 wt % of CaO; and 0.01 to 2 wt % of one or more of Ag₂O, Ag₃PO₄ and AgNO₃ are mixed and stirred to form an antibacterial glass composition.

In this step, SiO₂ is added more than B₂O₃, for example.

Additionally, it is preferable that B₂O₃ and one or more of Ag₂O, Ag₃PO₄ and AgNO₃ satisfy formula 1 described hereafter.

[B₂O₃]/[one or more of Ag₂O,Ag₃PO₄ and AgNO₃]≤50 Formula 1:

(In formula 1, [ ] denotes wt % of each component.)

The antibacterial glass composition may further include 15 wt % or less of TiO₂.

Additionally, a total content of 5 to 30 wt % of CaO and TiO₂ is added, for example.

Melting Step

In the melting step (S120), the antibacterial glass composition is melted.

The melting step is performed at 1,200 to 1,300° C. for 1 to 60 minutes, for example. The antibacterial glass composition cannot be completely melted at less than 1,200° C. for less than 1 minute, causing the unmixing of the molten object of glass can occur. Further, the antibacterial glass composition does not need to be melted at greater than 1,300° C. for greater than 60 minutes, only to spend excessive energy and time.

Cooling Step

In the cooling step (S130), the melted antibacterial glass composition cools up to room temperature.

In the cooling step, it is preferable to perform cooling in furnace. During air cooling or water cooling, antibacterial glass may have high internal stress, and in some cases, the antibacterial glass may have a crack. To prevent this from happening, cooling in furnace is preferable.

Grinding Step

In the grinding step (S140), the cooled antibacterial glass is ground. In the grinding step, a dry type grinder is preferable.

In the grinding step, the antibacterial glass is ground finely, and antibacterial glass power is manufactured. The antibacterial glass powder preferably has an average diameter of 30 μm or less, more preferably, 15 to 25 μm.

### Embodiment 1

<Manufacturing of Antibacterial Glass Composition>

Antibacterial glass compositions having composition ratios in table 1 shown hereafter were manufactured. A raw material for each component was sufficiently mixed in a V-mixer for three hours. Na₂CO₃, K₂CO₃, Li₂CO₃ and CaCO₃ were respectively used as a raw material for Na₂O, K₂O, Li₂O and CaO. The remaining components are listed in table 1. The mixed materials melted sufficiently at 1300° C. for 30 minutes, and rapidly cooled in a quenching roller, to obtain a glass cullet.

To manufacture an antibacterial glass composition, initial granularity of the glass cullet obtained in the above processes was controlled with a ball mill, was ground for about five hours using a jet mill, and then passed through a 325 mesh sieve (ASTM C285-88) such that a D50 particle diameter was limited to 5 to 15 μm, and finally, antibacterial glass powder was manufactured.

TABLE 1

| | | | | Comparative | Comparative |
|---|---|---|---|---|---|
| | | | | example | example |
| Component | Embodiment 1 | Embodiment 2 | Embodiment 3 | 1 | 2 |
| SiO2 | 27.4 | 27.4 | 24.2 | 30.6 | 40 |
| B2O3 | 21 | 10.5 | 14.1 | 23.5 | 7.8 |
| Na2O | 11.6 | 11.6 | 10.5 | 12.9 | 12.2 |
| K2O | 6.3 | 6.3 | 3.4 | 7.1 | 6.7 |
| Li2O | 2.1 | 2.1 | 3.7 | 2.4 | — |
| CaO | 31.6 | 42.1 | 44.1 | — | 11.1 |
| ZnO | — | — | — | 23.5 | 22.2 |

<Manufacturing of Antibacterial Glass-Added Plastic Injection Molded Object>

Polypropylene resin was used to manufacture an approximate 200 mm×100 mm injection molded object having a thickness of 3 mm. Three injection molded objects respectively containing 4 wt % of the antibacterial glass powder in embodiments 1 to 3 were manufactured, and two injection molded objects respectively containing 4 wt % of the antibacterial glass powder in comparative examples 1 and 2 were manufactured. In relation to the five injection molded objects, an anti-bio film was tested.

### Experimental Example—Antibacterial Activation Level, Anti-Bio Film

The antibacterial properties of the injection molded objects manufactured in the embodiments and comparative examples were evaluated as follows.

To see the antibacterial activity of the antibacterial glass composition according to the present disclosure, the ASTM E2149-13a shake flask method was applied.

To see the effect of the anti-bio film, the ASTM E2562-12 standard test method was applied.

TABLE 2

| | | | | Comparative | Comparative |
|---|---|---|---|---|---|
| | | | | example | example |
| | Embodiment 1 | Embodiment 2 | Embodiment 3 | 1 | 2 |
| Antibacterial activation | 99.9% | 99.9% | 99.9% | 40% | 24% |
| level | | | | | |
| (ASTM E2149- | | | | | |
| 13a shake flask method) | | | | | |
| Escherichia coil | | | | | |
| Anti-bio film | 98% | 98% | 98% | 65% | 43% |
| (ASTM E2562-12) | | | | | |
| Pseudomonas aeruginasa | | | | | |
| Ambient pH | 10.62 | 11.22 | 11.43 | 7.81 | 7.51 |

As shown in table 2, the embodiments according to the present disclosure exhibit excellent antibacterial performance.

Unlike the embodiments, the comparative examples exhibit unsatisfactory antibacterial performance.

### Embodiment 2

1. Manufacturing of Antibacterial Glass Power

### Embodiment 2-1

The antibacterial glass composition having the composition listed in table 3 was melted at 1,250° C. in an electric furnace, and then cooled on a stainless steel plate in glass bulk form during air coiling, to obtain antibacterial glass in the form of a cullet. Then the antibacterial glass was ground with a dry type grinder (a ball mill), and then passed through a 400 mesh sieve to manufacture antibacterial glass powder having a D50 particle diameter of 15 μm.

### Embodiment 2-2

Antibacterial glass powder having a D50 particle diameter of 20 μm was manufactured in the same way as that in embodiment 2-1 except that the antibacterial glass composition having the composition of table 3 in embodiment 2-2 was melted at 1,240° C. in an electric furnace.

### Embodiment 2-3

Antibacterial glass powder having a D50 particle diameter of 22 μm was manufactured in the same way as that in embodiment 2-1 except that the antibacterial glass composition having the composition of table 3 in embodiment 2-3 was melted at 1,250° C. in an electric furnace.

### Comparative Example 2-1

Antibacterial glass powder having a D50 particle diameter of 15 μm was manufactured in the same way as that in embodiment 2-1 except that the antibacterial glass composition having the composition of table 3 in comparative example 2-1 was melted at 1,250° C. in an electric furnace.

### Comparative Example 2-2

Antibacterial glass powder having a D50 particle diameter of 20 μm was manufactured in the same way as that in embodiment 2-1 except that the antibacterial glass composition having the composition of table 3 in comparative example 2-2 was melted at 1,260° C. in an electric furnace.

TABLE 3
(Unit: wt %)

| | | | | Comparative | Comparative |
|---|---|---|---|---|---|
| | | | | example | example |
| Component | Embodiment 2-1 | Embodiment 2-2 | Embodiment 2-3 | 2-1 | 2-2 |
| SiO₂ | 37.8 | 35.8 | 35.9 | 30.6 | 39.8 |
| B₂O₃ | 35.3 | 35.2 | 33.5 | 23.5 | 7.7 |
| Na₂O | 8.8 | 8.4 | 8.4 | 12.9 | 12.2 |
| K₂O | 8.8 | 8.4 | 8.4 | 7.1 | 6.6 |
| Li₂O | — | — | — | 2.4 | — |
| ZnO | — | — | — | 23.5 | 22.1 |
| CaO | 8.8 | 7.0 | 8.4 | — | 11.1 |
| TiO₂ | — | 4.5 | 4.8 | — | — |
| Ag₂O | 0.5 | — | — | — | 0.4 |
| AgNO₃ | — | 0.7 | — | — | — |
| Ag₃PO₄ | — | — | 0.6 | — | — |
| Total | 100 | 100 | 100 | 100 | 100 |

2. Measurement of Antibacterial Activation Level

Table 4 shows results of measurement of the antibacterial activation level of the antibacterial glass powder manufactured in embodiments 2-1 to 2-3 and comparative examples 2-1 to 2-2. In this case, to see the antibacterial activation level of each antibacterial glass powder, the ASTM E2149-13a shake flask method was applied, and an antibacterial activity value against Staphylococcus aureus and Escherichia coli was measured. Additionally, antibacterial activity against pneumococcus and Pseudomonas aeruginosa was measured.

Further, to see the antifungal activation level of each antibacterial glass powder, a mixed solution in which the antibacterial glass powder manufactured in embodiments 1 to 3 and comparative example 1 was mixed with distilled water was coated with a thickness of 100 μm on a sample made of a bamboo playwood plate of 50 mm (width), 50 mm (length) and 4 mm (thickness), cured and then tested with the ASTM G21-15 antifungal activation test method (strains for use: Aspergillus niger ATCC 9642, Chaetomium globosum ATCC 6205, Penicillium pinophilum ATCC 11797, Gliocladium virens ATCC 9645, Aureobasidium pullulans ATCC 15233).

<Criteria for Determining Antifungal Activation Level>

Grade 0: The strains cannot grow.

Grade 1: The strains grow on the sample at 10% or less.

Grade 2: The strains grow on the sample at greater than 10% to 30% or less.

Grade 3: The strains grow on the sample at greater than 30% to 60% or less.

Grade 4: The strains grow on the sample at greater than 60%.

TABLE 4

| | | | | | Comparative | Comparative |
|---|---|---|---|---|---|---|
| | | Embodiment | Embodiment | Embodiment | example | example |
| Category | | 2-1 | 2-2 | 2-3 | 2-1 | 2-2 |
| One or more of B₂O₃/Ag₂O, | | 70.6 | 50.3 | 55.8 | — | 19.25 |
| Ag₃PO₄ and AgNO₃ | | | | | | |
| Antibacterial | Staphylococcus | 99.9% | 99.9% | 99.9% | 40.0% | Ag precipitated |
| activation level | aureus | | | | | (No vitrification) |
| (ASTM E2149- | Escherichia coil | 99.9% | 99.9% | 99.9% | 42.9% | |
| 13a, shake | Klebsiella | 99.9% | 99.9% | 99.9% | 73.8% | |
| flask method) | pneumoniae | | | | | |
| | Pseudomonas | 99.9% | 99.9% | 99.9% | 91.2% | |
| | aeruginosa | | | | | |

| | | | | |
|---|---|---|---|---|
| Antifungal activation level | 0 | 0 | 0 | 1 |
| (ASTM G21-15, antifungal | | | | |
| activation test method) | | | | |

As shown in table 3 and 4, the antibacterial glass powder manufactured in embodiments 2-1 to 2-3 exhibit 99% or greater of an antibacterial activation level.

However, the antibacterial glass powder manufactured in comparative example 2-1 exhibits approximate 92% or less of an antibacterial activation level.

Additionally, comparative example 2-2 was not vitrified due to the precipitated Ag. Comparative example 2-2 satisfies the range of B₂O₃ suggested in the present disclosure, but do not satisfy formula 1. As a result, it is thought that Ag was precipitated.

Further, based on results of measurement of the antifungal activation level, the antibacterial glass powder manufactured in embodiments 2-1 to 2-3 shows grade 0 at which the strains did not grow, in the antifungal activation level. However, the antibacterial glass powder manufactured in comparative example 2-1 shows grade 1 in the antifungal activation level, indicating that the antifungal activation is not good.

The embodiments are described above with reference to a number of illustrative embodiments thereof. However, embodiments are not limited to the embodiments and drawings set forth herein, and numerous other modifications and embodiments can be drawn by one skilled in the art within the technical scope of the disclosure. Further, the effects and predictable effects based on the configurations in the disclosure are to be included within the range of the disclosure though not explicitly described in the description of the embodiments.

1. An antibacterial glass composition, comprising:
20 to 40 wt % of SiO₂;
5 to 25 wt % of B₂O₃;
15 to 25 wt % of one or more of Na₂O, K₂O, or Li₂O; and
25 to 45 wt % of CaO.

2. The antibacterial glass composition of claim 1, wherein the antibacterial glass composition comprises a SiO₂ content that is greater than a B₂O₃ content.

3. The antibacterial glass composition of claim 1, wherein the antibacterial glass composition comprises 30 to 45 wt % of CaO.

4. A manufacturing method of an antibacterial glass composition, the manufacturing method comprising:
providing materials for an antibacterial glass composition, the material comprising:
20 to 40 wt % of SiO₂;
5 to 25 wt % of B₂O₃;
15 to 25 wt % of one or more of Na₂O, K₂O, or Li₂O; and
25 to 45 wt % of CaO;
melting the materials for the antibacterial glass composition; and
cooling the melted materials for the antibacterial glass composition in a quenching roller.

5. The manufacturing method of claim 4, wherein the materials for the antibacterial glass composition comprise a SiO₂ content that is greater than a B₂O₃ content.

6. The manufacturing method of claim 4, wherein the antibacterial glass composition comprises 30 to 45 wt % of CaO.

7. An antibacterial glass composition, comprising:
20 to 45 wt % of SiO₂;
5 to 40 wt % of B₂O₃;
5 to 30 wt % of one or more of Na₂O, K₂O, or Li₂O;
5 to 20 wt % of CaO; and
0.01 to 2 wt % of one or more of Ag₂O, Ag₃PO₄, or AgNO₃.

8. The antibacterial glass composition of claim 7, wherein antibacterial glass composition comprises more SiO₂ than B₂O₃.

9. The antibacterial glass composition of claim 7, wherein:
[the wt % of B₂O₃]/[the wt % of the one or more of Ag₂O,Ag₃PO₄, or AgNO₃]≤50.

10. The antibacterial glass composition of claim 7, wherein the antibacterial glass composition further comprises 15 wt % or less of TiO₂.

11. The antibacterial glass composition of claim 10, wherein the antibacterial glass composition comprises 5 to 30 wt % of CaO and TiO₂.

12. A manufacturing method of antibacterial glass powder, comprising:
providing an antibacterial glass composition that includes:
20 to 45 wt % of SiO₂;
5 to 40 wt % of B₂O₃;
5 to 30 wt % of one or more of Na₂O, K₂O, or Li₂O;
5 to 20 wt % of CaO; and
0.01 to 2 wt % of one or more of Ag₂O, Ag₃PO₄, or AgNO₃;
melting the antibacterial glass composition;
cooling the melted antibacterial glass composition; and
grinding the cooled antibacterial glass composition.

13. The manufacturing method of claim 12, wherein the antibacterial glass composition includes more SiO₂ than B₂O₃.

14. The manufacturing method of claim 12, wherein:
[the wt % of B₂O₃]/[the wt % of the one or more of Ag₂O,Ag₃PO₄, or AgNO₃]≤50.

15. The manufacturing method of claim 12, wherein the antibacterial glass composition further comprises 15 wt % or less of TiO₂.

16. The manufacturing method of claim 15, wherein in the antibacterial glass composition comprises 5 to 30 wt % of CaO and TiO₂.

17. The manufacturing method of claim 12, wherein in melting the antibacterial glass composition, the antibacterial glass composition is melted at 1,200 to 1,300° C. for 1 to 60 minutes.
